(19) United States
(12) Patent Application Publication
(10) Pub. No.: US 2014/0039764 A1
(43) Pub. Date: Feb. 6, 2014

(54) CONTROLLER PRE-SHIPMENT INSPECTION METHOD

(71) Applicant: DENSO CORPORATION, Kariya-city (JP)

(72) Inventor: Makoto Aso, Miyoshi-city (JP)

(73) Assignee: DENSO CORPORATION, Kariya-city (JP)

(21) Appl. No.: 13/956,603

(22) Filed: Aug. 1, 2013

(30) Foreign Application Priority Data
Aug. 2, 2012 (JP) 2012-171878

(51) Int. Cl. G06F 17/00

(52) U.S. Cl. CPC G06F 17/00
USPC 701/45

(57) ABSTRACT

A pre-inspection method for inspecting an airbag controller prior to shipping the controller as a finished product is provided. The controller has a wiring board, a microcomputer, a memory, and a connector to operate the microcomputer according to a control program that is written into the memory.

The pre-shipment inspection method may entail implementing the microcomputer, the memory, and the connector on the wiring board, writing an inspection program in the memory, inspecting whether the hardware of the controller has an abnormality by operating the microcomputer according to the inspection program, erasing the inspection program from the memory, and writing the control program into the memory after erasing the inspection program from the memory.

### CROSS-REFERENCE TO RELATED APPLICATION

This application is based on and claims the benefit of priority of Japanese Patent Application No. 2012-171878 filed on Aug. 2, 2012, the disclosure of which is incorporated herein by reference.

### TECHNICAL FIELD

The present disclosure generally relates to a pre-shipment inspection method of a controller.

### BACKGROUND

Typically, a pre-shipment inspection method is used to inspect a controller prior to shipment. For example, Japanese Patent Laid-Open No. H06-316248 discloses a method for inspecting an airbag controller.

Generally, an airbag controller includes an acceleration sensor, a squib ignition circuit, and an airbag control computer. Further, the airbag control computer includes a read-only memory (ROM). The ROM has a control program to control an airbag and an inspection program dedicated to pre-shipment inspection. Prior to shipping, the airbag controller may be subject to a pre-shipment inspection. At the time of pre-shipment inspection, the airbag control computer executes the inspection program, which has been written in the ROM together with the control program, in order to inspect the airbag control computer for any abnormalities prior to the shipping of the airbag controller. If no abnormalities are detected during the pre-shipment inspection, the airbag control computer operates according to the control program and functions to protect a vehicle occupant by controlling the squib ignition circuit according to detection results from an acceleration sensor.

The capacity of the ROM is determined based on the size of the control program. The inspection program is written into the ROM within an available memory space remaining after the writing of the control program into the ROM. Therefore, depending upon the size of the control program, the available amount of memory reserved for the inspection program within the ROM may not be sufficient. As a consequence, the inspection program may include only a basic pre-shipment inspection (i.e., having only minimal inspection items) to ensure that the inspection program is sufficiently small to be written within the available amount of memory within the ROM.

Alternatively, an inspection program may utilize a control program to perform a pre-shipment inspection and determine whether an abnormality exists within the hardware and/or the operation of a controller. As a result, the inspection program may utilize the functionality of the control program to inspect the controller, which may minimize the size of the inspection program without decreasing the quantity of inspection content and/or items. However, also as a consequence, the inspection time may increase because the controller must simultaneously execute the inspection program and the control program. Further, control programs may vary from vehicle to vehicle (e.g., different control programs may be required for different vehicle-types and/or models). Therefore, the inspection criteria must also vary from vehicle to vehicle. That is, more practically, different pre-shipment inspection procedures may be required depending on the vehicle. As a result, standardization of the pre-shipment inspection steps and/or procedure may be difficult.

### SUMMARY

It is an object of the present disclosure to provide a pre-shipment inspection method for inspecting a controller to reduce inspection time relative to conventional methods and standardize pre-shipment inspection procedure.

In an aspect of the present disclosure, the present disclosure is in regards to a pre-shipment inspection method for inspecting a controller that controls an occupant protection apparatus, in which the controller has a wiring board, a microcomputer, a memory, and a connector to operate the microcomputer according to a control program that is written into the memory. The pre-shipment inspection method may entail writing an inspection program in the memory after implementing the microcomputer, the memory, and the connector on the wiring board, inspecting whether the hardware of the controller has an abnormality by operating the microcomputer according to the inspection program after the inspection program write step, and writing the control program into the memory after erasing the inspection program from the memory and after the hardware inspection step.

According to the present method, the inspection program write step is a step that writes the inspection program into the memory before the writing of the control program into the memory. Therefore, the amount of the memory available for storing the inspection program is sufficient since both the control program and the inspection program are not stored within the memory at the same time. Thus, the inspection program may include various inspection items for providing comprehensive inspection coverage to ensure that the pre-shipment inspection is sufficiently performed. Further, the hardware inspection step of the present disclosure operates the microcomputer according to the inspection program to inspect and determines whether the hardware of the controller has an abnormality. The operation of the microcomputer is not inspected during hardware inspection step. Therefore, there is no need to simultaneously execute the control program with the inspection program for the purpose of hardware inspection, as conventionally performed. Thus, the inspection time may be reduced and the pre-shipment inspection procedure may be standardized.

### BRIEF DESCRIPTION OF THE DRAWINGS

Other objects, features and advantages of the present disclosure will become more apparent from the following detailed description disposed with reference to the accompanying drawings, in which:

FIG. 1 is a block diagram of an airbag apparatus in a first embodiment of the present disclosure;

FIG. 2 is a top view of a wiring board of an airbag controller in FIG. 1; and

FIG. 3 is a flowchart of a manufacturing process of the airbag controller in FIG. 1.

### DETAILED DESCRIPTION

### First Embodiment

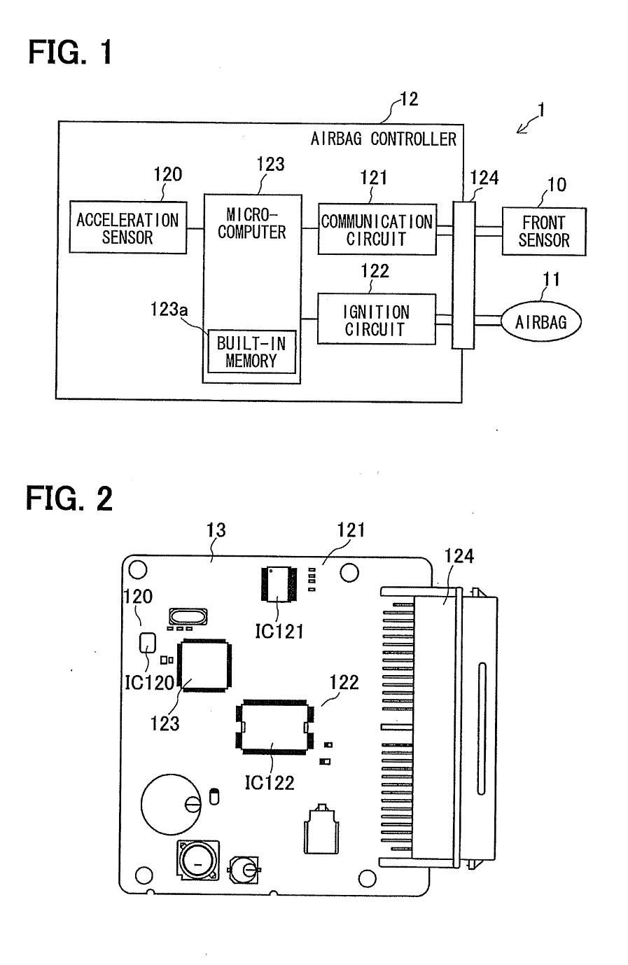

The first embodiment of the airbag apparatus is described with reference to FIG. 1.

An airbag apparatus 1 shown in FIG. 1 is an apparatus for protecting a vehicle occupant, which detects a frontal collision of the vehicle. The airbag apparatus 1 includes a front sensor 10 and an airbag 11 (i.e., a vehicular occupant protection device) and an airbag controller 12 (i.e., a controller in claims).

The front sensor 10 is disposed at a front part of the vehicle, detects an impact in a front-rear direction as an acceleration of the vehicle, and transmits the detected acceleration to other devices. The front sensor 10 is connected to the airbag controller 12.

The airbag 11 is a device installed in front of the vehicle occupant, for protecting the vehicle occupant by a deployment of a bag upon having an ignition electric current. The airbag 11 is connected to the airbag controller 12.

The airbag controller 12 is a device, in which an acceleration sensor 120 determines a frontal collision of the vehicle based on a detection result of the acceleration sensor 120 and a detection result of the front sensor 10. The airbag controller 12 includes the acceleration sensor 120, a communication circuit 121, an ignition circuit 122, a microcomputer 123, and a connector 124.

The acceleration sensor 120 is a sensor disposed in an inside of the airbag controller 12, for detecting an impact in a front-rear direction as an acceleration of the vehicle and for transmitting such an acceleration as a signal. The acceleration sensor 120 is connected to the microcomputer 123.

The communication circuit 121 is a circuit that converts a detection result transmitted from the front sensor 10 into a predetermined form and outputs the predetermined form to the microcomputer 123. The communication circuit 121 is connected to the front sensor 10 through the connector 124. Further, the communication circuit 121 is also connected to the microcomputer 123.

The ignition circuit 122 is a circuit controlled by the microcomputer 123 for providing an electric current to the airbag 11 for the deployment of the airbag 11. The ignition circuit 122 is connected to the microcomputer 123. Further, the ignition circuit 122 is also connected to the airbag 11 through the connector 124.

The microcomputer 123 is an element that operates according to the control program, determines a frontal collision of the vehicle based on a detection result of the acceleration sensor 120 and a detection result of the front sensor 10 that is input through the communication circuit 121, and controls a deployment of the airbag 11 through the ignition circuit 122. Further, the microcomputer 123 operates according to the inspection program at a time of pre-shipment inspection, for inspecting whether there is an abnormality of hardware of the airbag controller 12. The microcomputer 123 includes a built-in memory 123a (i.e., a memory in claims) to store a program. The microcomputer 123 is connected to the acceleration sensor 120, the communication circuit 121, and the ignition circuit 122, respectively.

Details of the configuration of the airbag controller 12 are described with reference to FIG. 2 in the following.

As shown in FIG. 2, a main part of the acceleration sensor 120, a main part of the communication circuit 121, and a main part of the ignition circuit 122 are respectively implemented as ICs 120 to 122, to be implemented on a wiring board 13 together with other electronic parts and serving as peripherals. Further, the microcomputer 123 having the built-in memory 123a and the connector 124 are also implemented on the wiring board 13. Further, the wiring board 13 has other electronic parts that form a power circuit or the like implemented thereon.

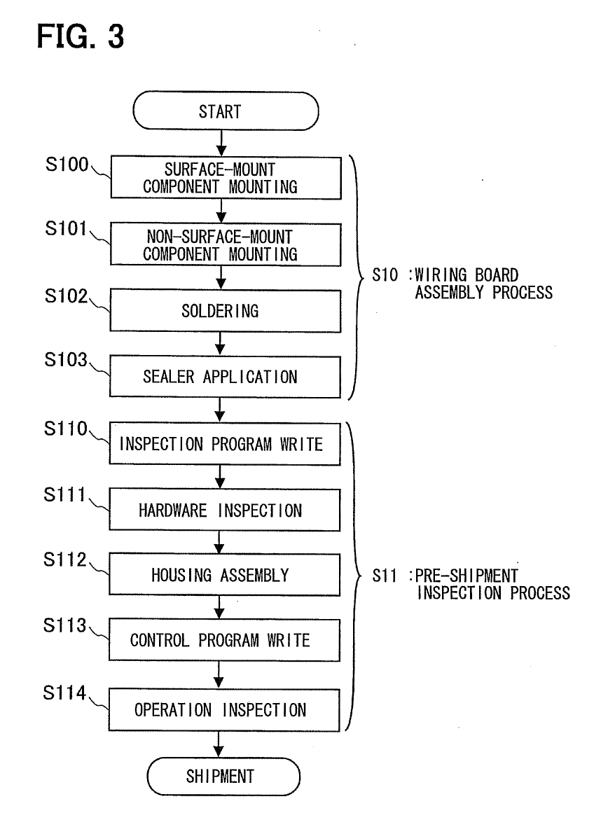

With reference to FIG. 2 and FIG. 3, a manufacturing procedure of the airbag controller 12, including a pre-shipment inspection procedure, is described.

As shown in FIG. 3, the manufacturing procedure of the airbag controller 12 includes a wiring board assembly process S10 and a pre-shipment inspection process S11.

The wiring board assembly process S10 is an implementation process to implement the following parts and the like on the wiring board 13. That is, the parts implemented in this step may be the electronic parts serving as the acceleration sensor 120, the communication circuit 121 and the ignition circuit 122 together with the microcomputer 123, the built-in memory 123a, and the connector 124 as well as other electronic parts not including the wiring board 13, as shown in FIG. 2. Further, as shown in FIG. 3, the wiring board assembly process S10 includes a surface-mount component mounting step S100, a non-surface-mount component mounting step S101, a soldering step S102, and a sealer application step S103.

The surface-mount component mounting step S100 is a step for mounting and fixing a surface-mount component on the wiring board 13, among the electronic components to be mounted on the wiring board 13. The non-surface-mount component mounting step S101 is a step for mounting and fixing other components other than the surface-mount components, from among the electronic components to be mounted on the wiring board 13, on the wiring board 13, after completion of the surface-mount component mounting step S100. The soldering step S102 solders, onto a land, a pad and the like, the electronic components that have been mounted on the wiring board 13, after completion of the non-surface-mount component mounting step S101. The sealer application step S103 is a step for applying a sealing material on the surface of the wiring board 13 on which the electronic components are mounted, after the soldering process S102.

By performing the wiring board assembly process S10, the wiring board 13 will be completed upon the implementing of the acceleration sensor 120, the communication circuit 121, the ignition circuit 122, the microcomputer 123 having the built-in memory 123a, the connector 124, and the electronic components other than the above.

Then, the pre-shipment inspection process S11 is performed. The pre-shipment inspection process S11 is a process for inspecting whether there is an abnormality in the hardware of the airbag controller 12 as well as inspecting whether an operation of the airbag controller 12 has any abnormality. The pre-shipment inspection process S11 includes an inspection program write step S110, a hardware inspection step Sill, a housing assembly step S112, a control program write process S113, and an operation inspection process S114.

The inspection program write step S110 is a step for writing an inspection program into the built-in memory 123a that is dedicated to hardware inspection, when the electronic components to be serving as the acceleration sensor 120, the communication circuit 121, the ignition circuit 122, together with the microcomputer 123 having the built-in memory 123a and the connector 124, as well as other electronic components other than the above have been implemented onto the wiring board 13. More practically, the inspection program is written into the built-in memory 123a without writing the program through the connector 124. That is, the inspection program is written into the built-in memory 123a by contacting a pin on the land, the pad or the like of the wiring board 13.

The hardware inspection step S111 follows the inspection program write process S110, in which the microcomputer 123 operates according to the inspection program written into the built-in memory 123a, for inspecting whether there is an abnormality in hardware of the airbag controller 12. That is, the microcomputer 123 operating according to the inspection program inspects whether the hardware has the abnormality by using the microcomputer 123 to output signals and the inspection program uses the responses to the output signals to determine whether the hardware has an abnormality. More practically, the microcomputer 123 operating according to the inspection program written into the built-in memory 123a outputs signals to various parts, and the response from the various parts is used by the inspection program to determine whether the various parts of hardware within the airbag controller 12 have an abnormality.

The housing assembly step S112 is a step following the hardware inspection step 6111 when the wiring board 13 is assembled onto a housing after it is determined in the hardware inspection step S111 that the hardware of the airbag controller 12 does not have any abnormality. A bar code sticker having a bar code containing model information of the airbag controller 12 is pasted on the housing, for indicating a suitable vehicle-type that the subject airbag controller 12 may be installed.

The control program write step S113 is a step for writing the control program into the built-in memory 123a after erasing the inspection program from the built-in memory 123a after completion of the housing assembly step S112. More practically, after obtaining the vehicle-type information from the bar code sticker pasted on the housing, the appropriate control program according to the obtained vehicle-type information is written into the built-in memory 123a through the connector 124.

The operation inspection step S114 is a step for operating the microcomputer 123 according to the control program and inspecting the operation of the microcomputer 123 by utilizing the control program to determine whether the microcomputer 123 is operating properly as the airbag controller 12. More practically, a signal that is equivalent to an output of the front sensor 10 is sent to the microcomputer 123 through the connector 124 from an inspection tool, and a response to such signal from the ignition circuit 122 is examined to determine whether the microcomputer 123 is properly operating as the airbag controller 12.

Then, if no abnormality is found in the airbag controller 12 during the operation inspection step S114, the airbag controller 12 is shipped as a product.

The advantageous effects of the present disclosure are described in the following.

According to the first embodiment, the surface-mount component mounting step S110 is a step for writing into the built-in memory 123a, an inspection program that is dedicated to inspecting hardware already implemented on the wiring board 13 such as the electronic components to be serving as the acceleration sensor 120, the communication circuit 121, the ignition circuit 122, the built-in memory 123a of the microcomputer 123, the connector 124, as well as other electronic components other than the above. The hardware inspection step S111 follows the inspection program write step S110, in which the microcomputer 123 operates according to the inspection program that is written into the built-in memory 123a to inspect whether there is an abnormality in the hardware of the airbag controller 12. The control program write step S113 is a step for writing the control program into the built-in memory 123a after erasing the inspection program from the built-in memory 123a and after completion of the housing assembly step S112 (i.e., after completion of the hardware inspection step S111). In other words, the inspection program write step S110 for writing the inspection program into the built-in memory 123a is a step performed in advance of the writing of the control program into the built-in memory 123a. Therefore, the control program write step S113 differs from a conventional method of writing the inspection program into an unwritten location within the remaining area of the built-in memory 123a after the control program has already been written into the memory 123a. Moreover, the built-in memory 123a may have sufficient capacity for storing the inspection program. In other words, the writing of the inspection program is no longer constrained by the storing capacity of the memory 123a since the memory 123a has sufficient capacity to store an inspection program that includes various inspection items for performing a thorough and complete inspection. As a result, a pre-shipment inspection having sufficient inspection coverage is provided by using such an inspection program. Further, the hardware inspection step S111 is a step in which the microcomputer 123 operates according to the inspection program, and inspects whether there is an abnormality in the hardware of the airbag controller 12. Therefore, the hardware inspection step S111 is different from a conventional inspection method that utilizes the control program to perform the inspection. As a result, the inspection time is reduced and the pre-shipment inspection procedure is standardized.

Also in the first embodiment, the hardware inspection step S111 is a step in which the microcomputer 123 only inspects whether there is an abnormality of the hardware of the airbag controller 12. Therefore, there is no need to perform an abnormality determination process with an inspection tool for determining the abnormality in the hardware inspection step S111. Thus, the inspection procedure is simplified.

Further, with regards to the first embodiment, the inspection program write step S110 is a step for writing the inspection program into the built-in memory 123a without using the connector 124. Similar to the control program, the connector 124 may be different from vehicle to vehicle. Therefore, when the connector 124 is used to write the inspection program into the built-in memory 123a, the connector 124 must be changed from one vehicle to the next. Changing the connector 124 from one vehicle to the next prohibits standardization of the inspection procedure. However, in the inspection program write step S110, the inspection program is written into the memory 123a without using the connector 124. Therefore, there is no change in the inspection procedure since no changing of the connector 124 is required from one vehicle to the next. As a result, standardization of the pre-shipment inspection procedure may be possible.

Even further, according to the first embodiment, the control program write process S113 is a step in which the control program is written into the memory 123a through the connector 124. Therefore, if the connector 124 is not functioning properly or has some abnormality, the control program may possibly be written improperly into the memory 123a. Thus, determining whether the connector 124 has an abnormality is also inspected in the operation inspection step S114.

Additionally in the first embodiment, the control program write step S113 is a step in which a suitable control program is written into the built-in memory 123a based on the model information of the airbag controller 12. Therefore, a suitable control program is securely written into the built-in memory 123a.

Also according to the first embodiment, the operation inspection step S114 is configured to be performed after the control program write step S113, for operating the microcomputer 123 and for inspecting an abnormality in the operation of the microcomputer 123 as the airbag controller 12. Therefore, the operation of the microcomputer 123 as the airbag controller 12 may be securely inspected for abnormalities.

Further, in the first embodiment, the operation inspection step S114 is a step for inspecting the abnormality of the operation of the microcomputer 123 as the airbag controller 12 by using an inspection tool that is connected through the connector 124. The connector 124 cannot output a signal properly if there is an abnormality in the connector 124. Therefore, the connector 124 is also inspected for abnormalities in step S114.

Even further, in the first embodiment, a subject device to be inspected by the pre-shipment inspection is an airbag controller 12 that controls the airbag 11. However, the subject device to be inspected by the pre-shipment inspection may be a device other than the airbag controller 12. For example, the device may be a seatbelt controller for controlling a seatbelt. The subject device may be any device as long as the subject device is a controller for controlling a vehicle occupant protection apparatus.

Although the present disclosure has been fully described in connection with the above embodiment thereof with reference to the accompanying drawings, it is to be noted that various changes and modifications will become apparent to those skilled in the art, and such changes and modifications are to be understood as being within the scope of the present disclosure as defined by the appended claims.

What is claimed is:

1. A pre-shipment inspection method for inspecting a controller, the controller controlling an occupant protection apparatus and having hardware that includes a wiring board, a microcomputer, a memory, and a connector to operate the microcomputer according to a control program, the method comprising:
an inspection program write step for writing an inspection program in the memory, wherein the inspection program write step is performed after implementing the microcomputer, the memory, and the connector on the wiring board;
a hardware inspection step for inspecting whether the hardware of the controller has an abnormality by operating the microcomputer according to the inspection program, wherein the hardware inspection step is performed after the inspection program write step; and
a control program write step for writing the control program in the memory after erasing the inspection program from the memory, wherein the control program write step is performed after the hardware inspection step.

2. The pre-shipment inspection method of claim 1, further wherein
the hardware inspection step is a step for inspecting whether the hardware has the abnormality by using the microcomputer.

3. The pre-shipment inspection method of claim 1, further wherein
the inspection program write step is a step for writing the inspection program into the memory without using the connector.

4. The pre-shipment inspection method of claim 1, further wherein
the control program write step is a step for writing the control program into the memory by using the connector.

5. The pre-shipment inspection method of claim 1, further wherein
the control program write step is a step for writing the control program according to model information of the controller.

6. The pre-shipment inspection method of claim 1, further comprising:
an operation inspection step for inspecting whether an operation of the microcomputer functioning as the controller according to the control program has an abnormality, wherein
the operation inspection step is performed after the control program write step.

7. The pre-shipment inspection method of claim 6, further wherein
the operation inspection step is a step for inspecting whether the operation of the controller has the abnormality by using an inspection tool that is connected to the microcomputer by using the connector.
